(19) United States
(12) Patent Application Publication
(10) Pub. No.: US 2008/0076876 A1
(43) Pub. Date: Mar. 27, 2008

(54) COATING COMPOSITIONS FOR ADHESION TO OLEFINIC SUBSTRATES

(75) Inventors: GREGORY G. MENOVCIK, NORTHVILLE, MI (US); WALTER H. OHRBOM, HARTLAND TOWNSHIP, MI (US); PAUL J. HARRIS, WEST BLOOMFIELD, MI (US); DAVID E. LINDOW, FARMINGTON HILLS, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, Southfield (US)

(21) Appl. No.: 11/534,682

(22) Filed: Sep. 25, 2006

(51) Int. Cl. C08L 53/00; B32B 27/00

(52) U.S. Cl. 525/89; 524/500

(57) ABSTRACT

An aqueous composition contains an olefinic polymer having an olefin portion that is substantially saturated and anionic functionality imparting water dispersibility. The olefinic polymer can be prepared by reacting a saturated or substantially saturated olefin polymer with a reactant that provides the water-dispersing functionality. The composition can be an adhesion promoter that provides excellent adhesion of subsequent coating layers to olefinic substrates like TPO or an additive in a different coating composition, which may be a curable coating composition, especially a primer composition, to provide excellent adhesion to olefinic substrates like TPO.

### FIELD OF THE DISCLOSURE

This disclosure relates to compositions that are applied over plastic substrates, particularly thermoplastic polyolefin (TPO) substrates.

### BACKGROUND OF THE DISCLOSURE

It is often desirable, for decorative or functional reasons, to apply a coating over a plastic substrate. It has been difficult to find coating compositions for certain substrates that provide the required adhesion at a reasonable price and with suitable physical properties It is well-known that it is difficult to obtain good adhesion of paints to olefinic substrates, including thermoplastic polyolefin (TPO) substrates and other such modified polyolefin-based materials.

In general, plastic substrates may be coated with curable, or thermosettable, coating compositions that cure below temperatures at which the plastic substrate would deform. Thermosettable coating compositions are widely used in the coatings art, particularly for high-performance primers and topcoats. Color-plus-clear composite coatings have been particularly useful as topcoats for which exceptional gloss, depth of color, distinctness of image, or special metallic effects are desired.

It has been necessary to include one or more additional separate manufacturing steps to prepare an olefinic substrate for painting so that the coating layer will be able to adhere to the olefinic substrate. According to one frequently used method, a thin layer of an adhesion promoter or tie layer is applied directly to the olefinic substrate. The desired coating layer or layers are then applied over the adhesion promoter,. Such adhesion promoters typically include a chlorinated polyolefin as the major or only vehicle component. Another method that has been used to prepare an olefinic substrate to receive a coating layer is chemical modification of the substrate surface, for example by flame or corona pretreatment.

Recently, coating compositions have included significant concentrations of adhesion promoting agents in order to achieve good adhesion to olefinic substrates. Published international application WO 97/35937 describes a composition that includes 5-45% by weight of resin solids of a substantially saturated polyhdroxylated polydiene polymer having terminal hydroxyl groups. International Publication Number WO 97/35937 and all of the references cited therein are hereby incorporated herein by reference. The international publication '937 discloses that such polymers are the hydrogenated product of dihydroxy polybutadiene produced by anionic polymerization of conjugated diene hydrocarbon capped with two moles of ethylene oxide and terminated with two moles of methanol. (The ethylene oxide produces the oxygenated anion, and the methanol provides the hydrogen cation to form the hydroxyl group.) The large amount of this adhesion promoting agent that must be included may adversely affect physical properties and appearance of the resulting coating,. In addition, compositions that include significant concentrations of the adhesion promoting agent may separate into phases because the different components frequently are not very compatible. The '937 reference requires a specific solvent package that may be undesirable in many instances. The same problems are encountered with other prior art adhesion promoting agents such as chlorinated polyolefins. It is also known that including chlorinated polyolefins in some coating compositions, e.g., curable coating compositions that include acid catalysts, can result in adverse interactions between the different components of the coating composition.

EP 0 982,337, published Mar. 1, 2000, describes an olefin-based block copolymer that has a substantially saturated olefin block and at least one (poly)ester or (poly)ether block. The olefin-based block copolymer can be used in an adhesion promoter to provide excellent adhesion of further coating layers to olefinic substrates like TPO. The olefin-based block copolymer can also be added, even at low levels, to other coating compositions, including curable coating compositions, to provide excellent adhesion to olefinic substrates. The adhesion promoter of the EP 0 982,337 publication offers significant cost advantage over chlorinated polyolefin-based adhesion promoters and provides adhesion to more standard coating compositions at modest levels that add little cost.

it would be desirable to provide a lower cost adhesion promoter or adhesion additive with improved performance under harsh testing conditions It would also be desirable to have an aqueous adhesion promoter to avoid the substantial organic emissions of prior adhesion promoters of this type.

### SUMMARY OF THE DISCLOSURE

The present disclosure describes an aqueous composition that includes an olefinic polymer that has a substantially saturated olefin portion and at least one ionizable group imparting water dispersibility to the polymer. The functionality imparting water dispersibility is ionized in dispersing the polymer. The olefin-based block copolymer can be prepared by reacting a saturated or substantially saturated olefin polymer with a reactant that provides the water-dispersing functionality to the polymer, wherein the olefin polymer has a functional group reactive with the reactant.

In certain embodiments, the olefinic polymer of the aqueous composition is substantially free of hydroxyl groups or has no hydroxyl groups.

In certain embodiments, the olefinic polymer has anionic groups.

In some embodiments, the olefinic polymer disperses a chlorinated polyolefin resin in the aqueous composition.

The aqueous composition that includes the olefinic polymer can be used as an adhesion promoter that provides excellent adhesion of subsequent coating layers to olefinic substrates like TPO. The aqueous composition including the olefinic polymer can also be used as an additive, even at relatively low levels, in a curable coating composition, especially a primer coating composition, to provide good adhesion of the coating to olefinic substrates like TPO. The adhesion promoter or coating composition of the invention can be applied directly to an unmodified plastic substrate, in other words to a plastic substrate that has no flame or corona pretreatment or any other treatment meant to chemically modify the surface of the substrate and to which no previous adhesion promoter or coating has been applied.

In certain embodiments in which the aqueous composition including the olefinic polymer is an additive in a curable coating composition, the olefinic polymer comprises functionality reactive with a curable component of the coating composition.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The saturated or substantially saturated polyolefin (referred to hereinafter as the “saturated polyolefin) used to prepare the olefinic polymer of the invention preferably has a number average molecular weight of at least about 1000 and in certain embodiments at least about 1500. The saturated polyolefin preferably has a number average molecular weight of up to about 5000 and in certain embodiments up to about 3500.

The saturated polyolefin is reacted with a reactant to provide at least one ionizable functionality imparting water dispersibility. The at least one functionality imparting water dispersibility. may be anionic or cationic. The ionizable groups may be acid groups including carboxylic acid groups, sulfonic acid groups, phosphonic acid groups, and phosphoric acid groups; or amine groups, including quarternary amine groups. In general, it is desirable to have at least one functional group imparting water solubility for each 1000 grams of polyolefin. The functional groups imparting water solubility may be adducted onto the polyolefin through reaction of terminal groups such as hydroxyl groups or groups along the polymer backbone, such as residual unsaturated groups or pendant hydroxyl groups. For examples, anhydrides such as trimellitic anhydride may be reacted with hydroxyl groups of the polyolefin. In another example, a hydroxyl group of the polyolefin may be reacted with a diisocyanate half-capped (that is, with one of its isocyanate groups reacted) with a polyacid such as a copolymer of acrylic acid or methacrylic acid or a high acid functional polyester resin.

The saturated polyolefin may have one or more additional functionalities that promote water dispersibility. Nonlimiting examples of other functionalities that may also be incorporated to impart water dispersibility include, without limitation, oxyethylene groups; oxyethylene-co-oxypropylene groups; activated, terminal carbamate groups such as beta- and gamma-carbamyloxyhydroxyalkyl groups; polyacrylamide groups.

In one embodiment, a carboxylic acid group is provided by reaction of a hydroxyl group on the saturated polyolefin with a cyclic anhydride. In another embodiment, a hydroxyl group on the saturated polyolefin may be reacted with phosphorous pentoxide to produce a phosphate acid. Nitric acid and sulfonic acid groups may be similarly incorporated.

In certain embodiments, the saturated polyolefin is hydroxyl functional. The saturated polyolefin may be adducted with a polyether block, polyester block, or polyurethane block to provide compatibility with the coating layer applied over the adhesion promoter or into which the adhesion promoter is placed. In certain embodiments an acrylate block may be used, as when a polyolefin with epoxide groups is reacted with, for example, an acid-functional free radical initiator or when an isocyanate functional polyolefin is reacted with a hydroxy-functional free radical initiator. The initiator group is then used for addition polymerization of the desired ethylenically unsaturated monomers. In addition, any of the controlled polymerization techniques can be used to incorporate one or two functional group into a polyacrylate for later reaction with the polyolefin. The polyether or polyester block may be added by reacting a saturated polyolefin having hydroxy functionality with a chain-extension reagent that is reactive with hydroxyl groups and will polymerize in a head-to-tail arrangement of monomer units. The hydroxyl-functional olefin forms an A block, while the chain-extension reagent forms a B block or blocks. Such chain-extension reagents include, without limitation, lactones, hydroxy carboxylic acids, oxirane-functional materials such as alkylene oxides, and combinations of these. Preferred chain-extension reagents are lactones and alkylene oxides, and even more preferred are epsilon-caprolactone, ethylene oxide, propylene oxide, and combinations of these.

The hydroxyl-functional olefin polymer may be produced by hydrogenation of a polyhydroxylated polydiene polymer. Polyhydroxylated polydiene polymers may produced by anionic polymerization of monomers such as isoprene or butadiene and capping the polymerization product with alkylene oxide and methanol, as described in U.S. Pat. Nos. 5,486,570, 5,376,745, 4,039,593, and Reissue 27,145, each of which is incorporated herein by reference. The polyhydroxylated polydiene polymer is substantially saturated by hydrogenation of the double bonds that is at least 90 percent, preferably at least 95% and even more preferably essentially 100% complete to form the hydroxyl-functional olefin polymer. The hydroxyl equivalent weight of the hydroxyl-functional saturated olefin polymer may be from about 500 to about 20,000.

In a preferred embodiment, the A block of the olefin-based block copolymer can be represented by the formula:

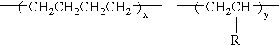

wherein R may be hydrogen or alkyl of from one to about 4 carbon atoms, preferably hydrogen or alkyl of from one to two carbon atoms; and wherein x and y represent the mole percentages of the indicated monomer units in the olefin polymer, the sum of x and y being 100 mole percent. In a preferred embodiment, R is hydrogen or ethyl, and x is preferably from about 60 mole percent to about 95 mole percent, more preferably from about 75 mole percent to about 90 mole percent.

The hydroxyl-functional olefin polymer is preferably a hydroxyl-functional hydrogenated copolymer of butadiene with ethylene, propylene, 1,2 butene, and combinations of these. The olefin polymers may have a number average molecular weight of preferably from about 1000 to about 10,000, more preferably from about 1000 to about 5000, even more preferably from about 1000 up to about 3500, and still more preferably from about 1500 up to about 3500. The olefin polymer also preferably has at least one hydroxyl group on average per molecule. Preferably, the olefin polymer has from about 0.7 to about 10 hydroxyl groups on average per molecule, more preferably from about 1.7 to about 2.2 hydroxyl groups on average per molecule, and still more preferably about 2 hydroxyl groups on average per molecule. The hydroxyl-functional olefin polymer preferably has terminal hydroxyl groups and a hydroxyl equivalent weight of from about 1000 to about 3000. Molecular weight polydispersities of less than about 1.2, particularly about 1.1 or less, are preferred for these materials.

The olefin polymer is preferably a low molecular weight poly(ethylene/butylene) polymer having at least one hydroxyl group. In another preferred embodiment the polyolefin polyol is a hydrogenated polybutadiene. In forming the hydrogenated polybutadiene polyol, part of the butadiene monomer may react head-to-tail and part may react by a 1,3 polymerization to yield a carbon-carbon backbone having pendent ethyl groups from the 1,3 polymerization. The relative amounts of head-to-tail and 1,3 polymerizations can vary widely, with from about 5% to about 95% of the monomer reacting head to tail. Preferably, from about 75 to about 95% of the monomer reacts head-to-tail. Among preferred hydrogenated polyolefin polyols are those available under the trademark POLYTAIL™ from Mitsubishi Chemical Corporation, Specialty Chemicals Company, Tokyo, Japan, including POLYTAIL™ H.

While not wishing to be bound by theory, it is believed that the mechanism that results in adhesion of the coating to the substrate involves a migration of the olefin-based block copolymer to the olefinic or TPO substrate interface and an interaction with the olefinic or TPO substrate. It is believed that the migration and/or interaction is facilitated by application of heat, such as the heat applied to cure the coating composition. Olefin-based block copolymers having narrower polydispersity (i.e., closer to the ideal of 1), in which high molecular weight fractions are less than for materials having similar number average molecular weights but broader (higher) polydispersity, are believed to offer an advantage in either better adhesion at lower levels of incorporation or effective adhesion achieved under milder conditions (lower temperatures and/or shorter interaction times). “Polydispersity,” also known simply as “dispersity,” is defined in polymer science as the ratio of the weight average molecular weight to the number average molecular weight. Higher polydispersity numbers indicate a broader distribution of molecular weights, and in particular mean a larger fraction of higher molecular weight species. The olefin-based block copolymer of the invention thus preferably has a narrow polydispersity.

When the olefin polymer is anionically polymerized it may have a very narrow polydispersity, such as on the order of only about 1.1. The ring-opening reactions of lactones and alkylene oxides or reactions of other materials that add head-to-tail like the hydroxy carboxylic acids tend to produce polymers that are more uniform and have narrow polydispersities. Modification of the olefin polymer by a head-to-tail reaction such as a ring-opening reaction of a lactone or alkylene oxide compound usually results in a product having a polydispersity of about 1.1 or 1.15, thus essentially preserving the narrow polydispersity of the hydroxyl-functional olefin starting material. Block copolymers of the invention preferably have polydispersities of about 1.2 or less, and more preferably have polydispersities of about 1.15 or less.

Again while not wishing to be bound by theory, it is believed that the modification of the olefin polymer by the (poly)ester or (poly)ether block or blocks offers significant advantages in providing adhesion of coatings to olefinic substrates because of increased compatibility of the resulting block copolymer toward materials commonly employed in such coatings. In addition, the imposition of the (poly)ester or (poly)ether block between the olefin block and the functional group, such as the hydroxyl group, makes that functional group more accessible for reaction during the curing of the coating composition,. These principles can be used to optimize the olefin-based block copolymer of the invention for use under particular conditions or with or in particular coating compositions.

In a preferred embodiment, the hydroxy-functional olefin polymer is reacted with a lactone or a hydroxy carboxylic acid to form an olefin-based polymer having (poly)ester end blocks. Lactones that can be ring opened by an active hydrogen are well-known in the art. Examples of suitable lactones include, without limitation, ε-caprolactone, γ-caprolactone, β-butyrolactone, β-propriolactone, γ-butyrolactone, α-methyl-γ-butyrolactone, β-methyl-γ-butyrolactone, γ-valerolactone, δ-valerolactone, γ-decanolactone, δ-decanolactone, γ-nonanoic lactone, γ-octanoic lactone, and combinations of these. In one preferred embodiment, the lactone is ε-caprolactone. Lactones useful in the practice of the invention can also be characterized by the formula:

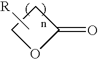

wherein n is a positive integer of 1 to 7 and R is one or more H atoms, or substituted or unsubstituted alkyl groups of 1-7 carbon atoms.

The lactone ring-opening reaction is typically conducted under elevated temperature (e.g., 80-150° C.). When the reactants are liquids a solvent is not necessary. However, a solvent may be useful in promoting good conditions for the reaction even when the reactants are liquid. Any non-reactive solvent may be used, including both polar and nonpolar organic solvents. Examples of useful solvents include, without limitation, toluene, xylene, methyl ethyl ketone, methyl isobutyl ketone, and the like and combinations of such solvents. A catalyst is preferably present Useful catalysts include, without limitation, proton acids (e.g., octanoic acid, Amberlyst® 15 (Rohm & Haas)), and tin catalysts (e.g., stannous octoate). Alternatively, the reaction can be initiated by forming a sodium salt of the hydroxyl group on the molecules that will react with the lactone ring.

A hydroxy carboxylic acid can also be used instead of a lactone or in combination with a lactone as the compound that reacts with the hydroxyl-functional olefin polymer to provide ester blocks. Useful hydroxy carboxylic acids include, without limitation, dimethylhydroxypropionic acid, hydroxy stearic acid, tartaric acid, lactic acid, 2-hydroxyethyl benzoic acid, N-(2-hydroxyethyl)ethylene diamine triacetic acid, and combinations of these. The reaction can be conducted under typical esterification conditions, for example at temperatures from room temperature up to about 150° C., and with catalysts such as, for example, calcium octoate, metal hydroxides like potassium hydroxide, Group I or Group II metals such as sodium or lithium, metal carbonates such as potassium carbonate or magnesium carbonate (which may be enhanced by use in combination with crown ethers), organometallic oxides and esters such as dibutyl tin oxide, stannous octoate, and calcium octoate, metal alkoxides such as sodium methoxide and aluminum tripropoxide, protic acids like sulfuric acid, or Ph₄Sbl. The reaction may also be conducted at room temperature with a polymer-supported catalyst such as Amerlyst-15® (available from Rohm & Haas) as described by R. Anand in Synthetic Communications, 24(19), 2743-47 (1994), the disclosure of which is incorporated herein by reference.

While polyester segments may likewise be produced with dihydroxy and dicarboxylic acid compounds, it is preferred to avoid such compounds because of the tendency of reactions involving these compounds to increase the polydispersity of the resulting block copolymer. If used, these compounds should be used in limited amounts and preferably employed only after the lactone or hydroxy carboxylic acid reactants have fully reacted.

The reaction with the lactone or hydroxy carboxylic acid or oxirane compounds adds at least one monomer unit as the B block and preferably provides chain extension of the olefin polymer. In particular, the (poly)ester and/or (poly)ether block is thought to affect the polarity and effective reactivity of the end group functionality during curing of the coating. The (poly)ester andfor (poly)ether block also makes the olefin-based block copolymer more compatible with components of a typical curable coating composition. The amount of the extension depends upon the moles of the alkylene oxide, lactone, and/or hydroxy carboxylic acid available for reaction. The relative amounts of the olefin polymer and the alkylene oxide, lactone, and/or hydroxy acid can be varied to control the degree of chain extension. The reaction of the lactone ring, oxirane ring, and/or hydroxy carboxylic acid with a hydroxyl group results in the formation of an ether or ester and a new resulting hydroxyl group that can then react with another available monomer, thus providing the desired chain extension. In the preferred embodiments of the present invention, the equivalents of oxirane, lactone, and/or hydroxy carboxylic acid for each equivalent of hydroxyl on the olefin polymer are from about 0.5 to about 25, more preferably from about 1 to about 10, and even more preferably from about 2 to about 6. In an especially preferred embodiment about 2.5 equivalents of lactone are reacted for each equivalent of hydroxyl on the olefin polymer.

In another embodiment of the invention, a polyolefin having terminal hydroxyl groups is reacted with an oxirane-containing compound to produce (poly)ether endblocks. The oxirane-containing compound is preferably an alkylene oxide or cyclic ether, especially preferably a compound selected from ethylene oxide, propylene oxide, butylene oxide, tetrahydrofuran, and combinations of these. Alkylene oxide polymer segments include, without limitation, the polymerization products of ethylene oxide, propylene oxide, 1,2-cyclohexene oxide, 1-butene oxide, 2-butene oxide, 1-hexene oxide, tert-butylethylene oxide, phenyl glycidyl ether, 1-decene oxide, isobutylene oxide, cyclopentene oxide, 1-pentene oxide, and combinations of these. The hydroxyl group of the olefin-based polymer functions as initiator for the base-catalyzed alkylene oxide polymerization. The polymerization may be carried out, for example, by charging the hydroxyl-terminated olefin polymer and a catalytic amount of caustic, such as potassium hydroxide, sodium methoxide, or potassium tert-butoxide, and adding the alkylene oxide at a sufficient rate to keep the monomer available for reaction. Two or more different alkylene oxide monomers may be randomly copolymerized by coincidental addition and polymerized in blocks by sequential addition.

Tetrahydrofuran polymerizes under known conditions to form repeating units

—[CH₂CH₂CH₂CH₂O]—

Tetrahydrofuran is polymerized by a cationic ring-opening reaction using such counterions as SbF₆⁻, AsF₆⁻, PF₆⁻, SbCl₆⁻, BF₄⁻, CF₃SO₃⁻, FSO₃⁻, and ClO₄⁻. Initiation is by formation of a tertiary oxonium ion. The polytetrahydrofuran segment can be prepared as a “living polymer” and terminated by reaction with the hydroxyl group of the olefin polymer.

After addition of the polyether or polyester blocks, the terminal hydroxyl group or groups can be adducted with an ionizable group, for example by reaction with a cyclic anhydride, phosphorous pentoxide, an acid-functional compound having an isocyanate group, or an isocyanate-functional compound having a blocked amino group that is regenerated after reaction between the isocyanate group and the terminal hydroxyl group.

It is also highly desirable for the olefin-based block copolymer of the invention to have functional groups that are reactive with one or more film-forming components of the adhesion promoter, or of the coating composition applied over an adhesion promoter containing the olefin-based block copolymer, or of the coating composition to which the olefin-based block copolymer is added. The film-forming components with which the olefin-based block copolymer may be reactive may be a film-forming polymer or a curing agent. The reactive functional groups on the olefin-based block copolymer may include, without limitation, hydroxyl, carbamate, urea, carboxylic acid, and combinations of these. Following addition of the ether or ester blocks, the block copolymer of the invention has one or more hydroxyl groups, which may be reactive with the film-forming polymer or curing agent. If desired, the hydroxyl groups may be converted to other functional groups, including carbamate, urea, carboxylic acid groups and combinations of these. In general, this can be accomplished by reaction with a polyester, polyether, polyurethane, or acrylic prepolymer with the desired functionality. Carbamate groups according to the invention can be represented by the structure

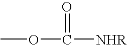

in which R is H or alkyl, preferably of 1 to 4 carbon atoms. Preferably R is H or methyl, and more preferably R is H. Urea groups according to the invention can be represented by the structure

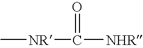

in which R′ and R″ are each independently H or alkyl, or R′ and R″ together form a heterocyclic ring structure. Preferably, R′ and R″ are each independently H or alkyl of from 1 to about 4 carbon atoms or together form an ethylene bridge, and more preferably R′ and R″ are each independently H. An hydroxyl group can be converted to a carbamate group by reaction with a monoisocyanate (e.g., methyl isocyanate) to form a secondary carbamate group (that is, a carbamate of the structure above in which R is alkyl) or with cyanic acid (which may be formed in situ by thermal decomposition of urea) to form a primary carbamate group (i.e., R in the above formula is H). This reaction preferably occurs in the presence of a catalyst as is known in the art. A hydroxyl group can also be reacted with phosgene and then ammonia to form a primary carbamate group, or by reaction of the hydroxyl with phosgene and then a primary amine to form a compound having secondary carbamate groups. Finally, carbamates can be prepared by a transesterification approach where hydroxyl group is reacted with an alkyl carbamate (e.g., methyl carbamate, ethyl carbamate, butyl carbamate) to form a primary carbamate group-containing compound. This reaction is performed at elevated temperatures, preferably in the presence of a catalyst such as an organometallic catalyst (e.g., dibutyltin dilaurate). A hydroxyl group can be conveniently converted to a carboxylic acid by reaction with the anhydride of a dicarboxylic acid. It is possible and may be desirable to derivatize the hydroxyl functional olefin-based block copolymer to have other functional groups other than those mentioned, depending upon the particular coating composition with which the olefin-based block copolymer is to interact.

The olefin-based block copolymer may be dispersed in an aqueous composition including water and, optionally, organic cosolvents. The ionizable group may be salted before or during dispersion in the water. Suitable salting materials for acid groups include, without limitation, bases such as ammonia, amines, and metal hydroxides. Suitable salting materials for amine groups include acids such as lactic acid, acetic acid, organic sulfonic acids such as para-toluene sulfonic acid, and phosphoric acids. It is advantageous in some instances to include in the block copolymer at least one polyethylene oxide segment. The aqueous dispersion may then be applied as an adhesion promoter or added to an aqueous coating composition as an aqueous dispersion of the block copolymer. Alternatively, the block copolymer may be blended with the film-forming polymer and then dispersed in water along with the film-forming polymer.

If desired, the olefin-based block copolymer can be combined with a chlorinated polyolefin to prepare the adhesion promoter. Some examples of chlorinated polyolefins can be found in U.S. Pat. Nos. 4,683,264; 5,102,944; and 5,319,032. Chlorinated polyolefins are known in the art and are commercially available form various companies, including Nippon Paper, Tokyo, Japan, under the designation Superchlon; Eastman Chemical Company, Kingsport, Tenn. under the designation CPO; and Toyo Kasei Kogyo Company, Ltd., Osaka, Japan under the designation Hardlen.

Chlorinated polyolefins typically have a chlorine content of at least about 10%, preferably at least about 15% by weight and up to about 40%, preferably up to about 30% by weight. Chlorinated polyolefins having a chlorine content of up to about 24% by weight are preferred. Even more preferred are chlorine contents of up to about 20% weight. It is also preferred for the chlorine content to be from about 15% to about 18% by weight. The chlorinated polyolefin in general may have number average molecular weight of from about 2000 to about 150,000, preferably from about 50,000 to about 90,000. Chlorinated polyolefins having number average molecular weights of from about 65,000 to about 80,000 are particularly preferred.

The chlorinated polyolefins may be based on grafted or ungrafted polyolefins such as, without limitation, chlorinated polypropylene, chlorinated polybutene, chlorinated polyethylene, and mixtures thereof. The non-grafted olefin polymer for chlorination can be homopolymers of alpha monoolefins with 2 to 8 carbon atoms, and the copolymers can be of ethylene and at least one ethylenically unsaturated monomer like alpha monoolefins having 3 to 10 carbon atoms, alkyl esters with 1 to 12 carbon atoms of unsaturated monocarboxylic acids with 3 to 20 carbon atoms, and unsaturated mono- or dicarboxylic acids with 3 to 20 carbon atoms, and vinyl esters of saturated carboxylic acids with 2 to 18 carbon atoms.

The graft copolymer base resins are reaction products of an alpha-olefin polymer and a grafting agent. The alpha-olefin homopolymer of one or copolymer of two alpha-olefin monomers with two to eight carbon atoms can include: a) homopolymers such as polyethylene and polypropylene, and b) copolymers like ethylene/propylene copolymers, ethylene/1-butene copolymers, ethylene/4-methyl-1-pentene copolymers, ethylene/1-hexene copolymers, ethylene/1-butene/1-octene copolymers, ethylene/1-decene copolymers, ethylene/4-ethyl-1l-hexene copolymers, and ethylene/4-ethyl-1-octene copolymers. Chlorinated grafted polypropylene can be prepared by solution chlorination of a graft-modified polypropylene homopolymer or propylene/alpha-olefin copolymer. Such grafting polymerization is usually conducted in the presence of a free radical catalyst in a solvent which is inert to chlorination. Fluorobenzene, chlorofluorobenzene carbon tetrachloride, and chloroform and the like are useful solvents. Typically, such grafted polypropylenes are those base resins that have been grafted with an alpha, beta-unsaturated polycarboxylic acid or an acid anhydride of an alpha, beta-unsaturated anhydride to form an acid-and/or anhydride-modified chlorinated polyolefin. Suitable grafting agents generally include maleic acid or anhydride and fumaric acid and the like.

Modified chlorinated polyolefins can include those modified with an acid or anhydride group. Examples of unsaturated acids that can be used to prepare an modified, chlorinated polyolefin include, without limitation, acrylic acid, methacrylic acid, maleic acid, citraconic acid, fumaric acid, the anhydrides of these. The acid content of the chlorinated polyolefin is preferably from about 0. 5% to about 6% by weight, more preferably from about 1% to about 3% by weight. Acid numbers of from about 50 to about 100 mg KOH/g may be preferred for the chlorinated polyolefin, particularly for waterborne compositions Also, the chlorinated polyolefin polymer can be a chlorosulfonated olefin polymer or a blend of the chlorinated polyolefin polymer with the chlorosulfonated olefin polymer, where chlorosulfonation may be effected by reaction of the grafted or non-grafted base resin with a chlorosulfonating agent.

The adhesion promoter compositions of the invention have a weight ratio of the olefin-based block copolymer to the chlorinated polyolefin that can be from about 1:99 to about 99:1. The weight ratio of the olefin-based block copolymer to the chlorinated polyolefin is preferably from about 1:3 to about 3:1. In making an aqueous dispersion, the olefin-based block copolymer and the chlorinated polyolefin may be combined before dispersion of the polymers in an aqueous medium. The ionizable groups of the olefin-based block copolymer may be salted before or after combination of the copolymer with the chlorinated polyolefin.

The adhesion promoter compositions may further include other components, including for example and without limitation crosslinking agents, pigments, fillers customary coatings additives, and combinations of these. Suitable crosslinking agents are reactive with the functionality on the olefin-based block copolymer, which may include the ionizable groups (e.,g., carboxylic acid or an amine group having a labile hydrogen) and/or reactive with a component of a coating applied over the adhesion promoter composition of the invention. Suitable pigments and fillers include, without limitation, conductive pigments, including conductive carbon black pigments and conductive titanium dioxide pigments; non-conductive titanium dioxide and carbon pigments, graphite, magnesium silicate, ferric oxide, aluminum silicate, barium sulfate, aluminum phosphomolybdate, aluminum pigments, and color pigments. The pigments and, optionally, fillers are typically included at a pigment to binder ratio of from about 0.1 to about 0.6, preferably from about 0.1 to about 0.25. Suitable additives include, without limitation, flow control or rheology control agents, matting agents, catalysts suitable for reaction of the particular crosslinker, flow control or rheology control agents, and combinations of these.

In one preferred embodiment, the adhesion promoter is a dispersion that includes only or essentially only the olefin-based block copolymer and optionally chlorinated polyolefin as the vehicle components. In this embodiment, it is preferred to first apply the adhesion promoter directly to the plastic substrate and then to apply a layer of a coating composition that includes one or more components reactive with either the olefin-based block copolymer or the optionally included chlorinated polyolefin, modified with functional groups such as acid or anhydride, of the adhesion promoter layer. Applying coating layers “wet-on-wet” is well known in the art.

In an alternative embodiment, the adhesion promoter further includes at least one crosslinking agent reactive with the olefin-based block copolymer and/or the optional chlorinated polyolefin components. The curing agent has, on average, at least about two crosslinking functional groups. Suitable curing agents for active-hydrogen functional olefin-based block copolymers include, without limitation, materials having active methylol or methylalkoxy groups, such as aminoplast crosslinking agents or phenol/formaldehyde adducts, curing agents that have isocyanate groups, particularly blocked isocyanate curing agents; curing agents having epoxide groups; and combinations of these. Examples of preferred curing agent compounds include melamine formaldehyde resins (including monomeric or polymeric melamine resin and partially or fully alkylated melamine resin), blocked or unblocked polyisocyanates (e.g., toluene diisocyanate, MDI, isophorone diisocyanate, hexamethylene diisocyanate, and isocyanurate trimers of these, which may be blocked for example with alcohols or oximes), urea resins (e.g., methylol ureas such as urea formaldehyde resin, alkoxy ureas such as butylated urea formaldehyde resin), polyanhydrides (e.g., polysuccinic anhydride), polysiloxanes (e.g., trimethoxy siloxane), and combinations of these. Unblocked polyisocyanate curing agents are usually formulated in two-package (2K) compositions, in which the curing agent and the film-forming polymer (in this case, at least the block copolymer) are mixed only shortly before application and because the mixture has a relatively short pot life,. The curing agent may be combinations of these, particularly combinations that include aminoplast crosslinking agents. Aminoplast resins such as melamine formaldehyde resins or urea formaldehyde resins are especially preferred. For this embodiment of the adhesion promoter, the applied adhesion promoter may be either coated “wet-on-wet” with a one or more coating compositions, and then all layers cured together, or the adhesion promoter layer may be partially or fully cured before being coated with any additional coating layers. Curing the adhesion promoter layer before applying an additional coating layer may allow the subsequent coating layer to be applied electrostatically when the adhesion promoter is formulated with a conductive pigment such as conductive carbon black or conductive titanium dioxide, according to methods known in the art.

Secondly, the ionizable, olefin-based block copolymer can be added to a variety of coating compositions to produce coating compositions that have excellent adhesion to plastic substrates, particularly to olefinic substrates, including TPO. Compositions in which the combination of the olefin-based block copolymer may be used include primers, one-layer topcoats, basecoats, and clearcoats. Preferably, the coating composition is aqueous, and the ionizable groups of the olefin-based block copolymer are ionized in dispersion in the coating composition. The coating composition may also be solventborne, in which case the ionizable group need not be salted. The coating composition may be a powder coating composition, including an aqueous powder slurry coating composition. The coating composition having the added block copolymer can then be applied directly to an uncoated and unmodified olefin-based substrate or other plastic to form a coating layer having excellent adhesion to the substrate.

The coating compositions of the invention preferably include at least about 0.001% by weight of the olefin-based block copolymer, based upon the total weight of nonvolatile vehicle. In one preferred embodiment, the olefin-based block copolymer is included in the coating composition in an amount of at least about 3%, more preferably at least about 5% by weight of the total weight of nonvolatile vehicle. The olefin-based block copolymer may be included in of the nonvolatile vehicle of the coating composition in amounts of preferably up to about 20% by weight, more preferably up to about 10% by weight of the total weight of nonvolatile vehicle. “Vehicle” is understood to be the resinous and polymer components of the coating composition, which includes film forming resins and polymers, crosslinkers, other reactive components such as the olefin-based block copolymer and other reactive or nonreactive resinous or polymeric components such as acrylic microgels.

The coating compositions of the invention may contain a wide variety of film-forming resins. At least one crosslinkable resin is included. The resin may be self-crosslinking, but typically a coating composition includes one or more crosslinking agents reactive with the functional groups on the film-forming resin Film-forming resins for coating compositions typically have such functional groups as, for example, without limitation, hydroxyl, carboxyl, carbamate, urea, epoxide (oxirane), primary or secondary amine, amido, thiol, silane, and so on and combinations of these. The film-forming resin may be any of those used in coating compositions including, without limitation, acrylic polymers, vinyl polymers, polyurethanes, polyesters (including alkyds), polyethers, epoxies, and combinations and graft copolymers of these. Also included are polymers in which one kind of polymer is used as a monomer in forming another, such as a polyester-polyurethane, acrylic-polyurethane, or a polyether-polyurethane in which a dihydroxy functional polyester, acrylic polymer, or polyether is used as a monomer in the urethane polymerization reaction. Preferred film-forming resins are acrylic polymers, and polyesters, including alkyds. Many references describe film-forming polymers for curable coating compositions and so these materials do not need to be described in further detail here.

Film-forming resins may be included in amounts of from about 5 to about 99%, preferably from about 20 to about 80% of the total solid vehicle of the coating composition. In the case of waterborne compositions, the film-forming resin is emulsified or dispersed in the water.

When the coating composition includes a curing agent, or crosslinker, the crosslinker is preferably reactive with both the olefin-based block copolymer and the polymeric film-forming resin. The curing agent has, on average, at least about two crosslinking functional groups, and is preferably one of the crosslinking materials already described above. Aminoplast resins such as melamine formaldehyde resins or urea formaldehyde resins are especially preferred for resin functional groups that are hydroxyl, carbamate, and/or urea. The coating compositions of the invention can be formulated as either one-component (one-package or 1 K) or two-component (two-package or 2K) compositions, as is known in the art.

The adhesion promoter or coating composition used in the practice of the invention may include a catalyst to enhance the cure reaction. For example, when aminoplast compounds, especially monomeric melamines, are used as a curing agent, a strong acid catalyst may be utilized to enhance the cure reaction. Such catalysts are well-known in the art and include, without limitation, p-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. Other catalysts that may be useful in the composition of the invention include Lewis acids, zinc salts, and tin salts.

A solvent may optionally be included in the coating composition used in the practice of the present invention, and preferably at least one solvent is included. In general, the solvent can be any organic solvent and/or water. It is possible to use one or more of a broad variety of organic solvents. The organic solvent or solvents are selected according to the usual methods and with the usual considerations. In a preferred embodiment of the invention, the coating composition is aqueous. The coating composition may contain a mixture of water with any of the typical co-solvents employed in aqueous dispersions.

Additional agents known in the art, for example and without limitation, surfactants, fillers, pigments, stabilizers, wetting agents, rheology control agents (also known as flow control agents), dispersing agents, adhesion promoters, UV absorbers, hindered amine light stabilizers, silicone additives and other surface active agents, etc., and combinations of these may be incorporated into the adhesion promoter or coating composition containing the olefin-based block copolymer.

The adhesion promoter and coating compositions can be coated on an article by any of a number of techniques well-known in the art. These include, without limitation, spray coating, dip coating, roll coating, curtain coating, and the like. Spray coating is preferred for automotive vehicles or other large parts.

The inventive combination of the chlorinated polyolefin and the olefin-based block copolymer can be added to a topcoat coating composition in amounts that do not substantially change the gloss of the topcoat. In one application, for example, the olefin-based block copolymer is utilized in a topcoat composition, in particular a clearcoat composition which produces a high-gloss cured coating, preferably having a 20° gloss (ASTM D523-89) or a DOI (ASTM E430-91) of at least 80 that would be suitable for exterior automotive components.

In another application, the olefin-based block copolymer may be included in a topcoat or primer composition that produces a low gloss coating, such as for coating certain automotive trim pieces,. Typical low gloss coatings have a gloss of less than about 30 at a 60° angle. the low gloss may be achieved by including one or more flatting agents. Low gloss primer compositions are often used to coat automotive trim pieces, such as in a gray or black coating. The low gloss primer is preferably a weatherable composition because the low gloss primer may be the only coating applied to such trim pieces. In the case of a weatherable primer, the resins are formulated to be light-fast and the composition may include the usual light stabilizer additives, such as hindered amine light stabilizers, UV absorbers, and antioxidants.

When the coating composition of the invention is used as a high-gloss pigmented paint coating, the pigment may include any organic or inorganic compounds or colored materials, fillers, metallic or other inorganic flake materials such as mica or aluminum flake, and other materials of kind that the art normally names as pigments. Pigments are usually used in the composition in an amount of 0.2% to 200%, based on the total solid weight of binder components (i.e., a pigment-to-binder ratio of 0.02 to 2). As previously mentioned, adhesion promoters preferably include at least one conductive pigment such as conductive carbon black pigment, conductive titanium dioxide, conductive graphite, conductive silica-based pigment, conductive mica-based pigment, conductive antimony pigment, aluminum pigment, or combinations of these, in an amount that makes the coating produced suitable for electrostatic applications of further coating layers.

The adhesion promoters and coating compositions can be applied at thicknesses that will produce dry film or cured film thicknesses typical of the art, such as from about 0.01 to about 5.0 mils. Typical thicknesses for adhesion promoter layers are from about 0.1 to about 0.5 mils, preferably from about 0.2 to about 0.3 mils. Typical thicknesses for primer layers are from about 0.5 to about 2.0 mils, preferably from about 0.7 to about 1.5 mils,. Typical thicknesses for basecoat layers are from about 0.2 to about 2.0 mils, preferably from about 0.5 to about 1.5 mils. Typical thicknesses for clearcoat layers or one-layer topcoats are from about 0.5 to about 3.0 mils, preferably from about 1.5 to about 2.5 mils.

After application to the substrate, the adhesion promoters and coating compositions of the invention are heated to facilitate interaction with the substrate and thus to develop the adhesion of the applied composition to the substrate. Preferably, the coated substrate is heated to at least about the softening temperature of the plastic substrate. The adhesion promoters and coating compositions are preferably thermally cured. Curing temperatures will vary depending on the particular blocking groups used in the crosslinking agents, however they generally range between 225° F. and 270° F. The curing temperature profile must be controlled to prevent warping or deformation of the TPO substrate or other plastic substrate. The first compounds according to the present invention are preferably reactive even at relatively low cure temperatures. Thus, in a preferred embodiment, the cure temperature is preferably between 230° F. and 270° F., and more preferably at temperatures no higher than about 250° F. The curing time will vary depending on the particular components used, and physical parameters such as the thickness of the layers, however, typical curing times range from 15 to 60 minutes, and preferably 20-35 minutes. The most preferred curing conditions depends upon the specific coating composition and substrate, and can be discovered by straightforward testing.

The coating compositions of the invention are particularly suited to coating olefinic substrates, including, without limitation, TPO substrates, polyethylene substrates, and polypropylene substrates. The coating compositions may also be used, however, to coat other thermoplastic and thermoset substrates, including, without limitation, polycarbonate, polyurethane, and flexible substrates like EPDM rubber or thermoplastic elastomers. Such substrates can be formed by any of the processes known in the art, for example, without limitation, injection molding and reaction injection molding, compression molding, extrusion, and thermoforming techniques.

The materials and processes of the invention can be used to form a wide variety of coated articles, including, without limitation, appliance parts, exterior automotive parts and trim pieces, and interior automotive parts and trim pieces.

The invention is further described in the following examples. The examples are merely illustrative and do not in any way limit the scope of the invention as described and claimed. All parts are parts by weight unless otherwise noted.

### Example of the Invention

A solution of 100 parts by weight hexamethylene diisocyanate in 100 parts by weight methyl amyl ketone is kept under an inert atmosphere in a reactor. One part by weight of dibutyl tin dilaurate is added to the reactor. Then, keeping the reaction temperature below about 50° C., 53 parts by weight glycerine carbonate are slowly added. Once the glycerine carbonate has been incorporated, 540 parts by weight of a polyolefin with hydroxyl equivalent weight of 1200 g/equiv. is added to cap the polyolefin with the synthesized cyclic carbonate-functional urethane prepolymer. Next, 150 parts by weight methanol is added to the reactor with a steady stream of ammonia gas bubbled into the reactor contents to transform the cyclic carbonate groups into hydroxy carbamate groups. Excess ammonia and methanol are removed by vacuum distillation. Finally, 92 parts by weight trimellitic anhydride is added to the reactor and the contents held to complete the reaction of the hydroxyl groups. The product is a polyolefin with carbamate equivalent weight of about 1750 g/equiv. and acid equivalent weight of about 875 g/equiv.

An aqueous composition is prepared by salting the acid groups with dimethylethanolamine and dispersing the salted product in deionized water. The aqueous dispersion has a pH of about 7.5 and a solids content of about 40% by weight.

The invention has been described in detail with reference to preferred embodiments thereof. It should be understood, however, that variations and modifications can be made within the spirit and scope of the invention and of the following claims.

What is claimed is:

1. An aqueous composition comprising a polymer comprising anionic groups, a substantially saturated, predominately hydrocarbon polymer portion and at least one further portion selected from the group consisting of (poly)ester blocks, poly(alkylene oxide) blocks and combinations thereof.

2. An aqueous composition according to claim 1, wherein the polymer is substantially free from hydroxyl groups.

3. An aqueous composition according to claim 1, further comprising a member selected from the group consisting of surfactants and dispersants.

4. An aqueous composition according to claim 3, comprising a surfactant comprising a poly(ethylene oxide)-co-(propylene oxide) block copolymer.

5. An aqueous composition according to claim 1, wherein the further portion comprises a poly(ethylene oxide) portion.

6. An aqueous composition according to claim 5, wherein the hydrocarbon portion and the further portion are linked with an ester group.

7. An aqueous composition according to claim 5, wherein the poly (ethylene oxide) portion has a weight of at least about 4000 daltons.

8. An aqueous composition according to claim 1, wherein the further portion comprises a functionality selected from the group consisting of activated urea groups, activated carbamate groups, amide groups, radicals of polymerized, water-soluble addition monomers, and combinations thereof.

9. An aqueous composition according to claim 8, further comprising a poly(ethylene oxide) portion.

10. An aqueous composition according to claim 1, comprising an anionic group.

11. An aqueous composition according to claim 1, comprising an anionic group and a poly(ethylene oxide) portion.
